(19) United States
(12) Patent Application Publication
(10) Pub. No.: US 2019/0354963 A1
(43) Pub. Date: Nov. 21, 2019

(54) CRYPTOGRAPHIC TRANSACTION PROCESSING SYSTEM AND CLIENT WALLET AND METHODS THEREFOR

(71) Applicant: DECENTRAL INC., Toronto (CA)

(72) Inventors: ANTHONY DI IORIO, TORONTO (CA); ADDISON CAMERON-HUFF, TORONTO (CA); NILANG VYAS, TORONTO (CA)

(21) Appl. No.: 15/979,981

(22) Filed: May 15, 2018

(51) Int. Cl. G06Q 20/36; G06Q 20/38; G06Q 20/06

(52) U.S. Cl. CPC G06Q 20/3678; G06Q 2220/00; G06Q 20/065; G06Q 20/3829

(57) ABSTRACT

A cryptographic transaction processing system provides read and write interfaces to one or more distributed ledger systems managing respective distributed ledger systems (e.g. blockchains). The system uses the read interfaces to obtain distributed ledger data for respective local data stores that store the data optimized for reading. The data includes confirmed and preferably unconfirmed transactions. Client facing interfaces are provided to client wallets to conduct transactions with respective ledgers. A registration interface is provided to wallets to register public parent keys for respective transaction addresses managed by the wallets for transactions conducted with the ledgers. The registration interface provides read registration identifiers in return. An identifier may be provided by a wallet in a single request for read operations by the system where the system generates addresses using the parent public key associated with the identifier rather than receive respective addresses in separate read requests.

### CROSS REFERENCE

This disclosure is related to Applicant's U.S. patent application Ser. No. ______, filed ______, having attorney docket number T8480316US and entitled “Cryptographic Transaction Signing Devices and Methods Therefor”, the contents of which are incorporated herein by reference.

### FIELD

This disclosure relates to cryptographic transaction processing system and client wallet and methods therefor, including systems, methods and devices to facilitate cryptocurrency transactions.

### BACKGROUND

There are various known manners to provide cryptocurrencies for sale to individuals and other desiring to purchase cryptocurrency. One such manner is to provide an Automated Teller Machine (ATM) or ATM-like machine that sells and may buy a cryptocurrency such as bitcoin in exchange for an amount of fiat currency. These machines are expensive to buy and require a fair bit of maintenance, manual removal of cash, connection with an exchange, and many other ongoing items. In short, it is an expensive business model to scale ATMs to service more customers in more locations.

### SUMMARY

A cryptographic transaction processing system provides read and write interfaces to one or more distributed ledger systems managing respective distributed ledger systems (e.g. blockchains). The system uses the read interfaces to obtain distributed ledger data for respective local data stores that store the data optimized for reading. The data includes confirmed and preferably unconfirmed transactions. Client facing interfaces are provided to client wallets to conduct transactions with respective ledgers. A registration interface is provided to wallets to register public parent keys for respective transaction addresses managed by the wallets for transactions conducted with the ledgers. The registration interface provides read registration identifiers in return. An identifier may be provided by a wallet in a single request for read operations by the system, where the system generates addresses using the parent public key associated with the identifier rather than receive respective addresses in separate read requests.

These and other aspects will be apparent from the disclosure herein including various computer system or device aspects, method aspects and computer program product aspects where a non-transitory storage device stores instructions which when executed by a processor configure a computer system or device to perform a method aspect.

There is provided a cryptographic transaction processing system comprising at least one processor in communication with at least one memory and at least one communication subsystem, the at least one memory storing instructions, which when executed by the at least one processor, configure the cryptographic transaction processing system to: for each of a plurality of distributed ledger transaction processing systems managing respective distributed ledgers: provide a respective write component to communicate respective write requests to perform cryptographic transactions with a respective one of the plurality of systems; and provide a respective read component to receive respective distributed ledger data from a respective one of the plurality of systems to define a respective data store synchronized with one of the respective distributed ledgers; provide a first client wallet facing component to receive respective write requests from a plurality of client wallets; and provide a second client wallet facing component to transmit respective distributed ledger data from each respective data store to the plurality of client wallets; and wherein a particular write request comprises signed cryptographic data having a transaction address associated with a particular client wallet initiating the particular write request for a particular cryptographic transaction; and wherein the respective distributed ledger data is associated with respective transaction addresses respectively managed by the plurality of client wallets and the second client wallet facing component uses the respective transaction addresses to determine which client wallet is to receive the respective distributed ledger data.

At least some of the respective distributed ledgers may be configured according to an unspent transaction output (“UTXO”) model and the transaction addresses for the at least some of the respective distributed ledgers are addresses to store unspent transaction outputs in respective ones of the at least some of the respective distributed ledgers.

The second client wallet facing component may: receive respective read requests from the plurality of client wallets for transaction data of the respective distributed ledgers, where a read request is associated with a particular transaction address; and process and respond to each read request using the respective data store responsive to the particular transaction address. Each of the respective read requests may include data identifying a particular one of the respective distributed ledgers for use to determine the respective data store to be used. The cryptographic transaction processing system may comprise a routing component to route each read request to a particular respective read component in accordance with an identification of one of the respective distributed ledgers in each read request, the routing component further routing each write request to a particular respective write component in accordance with an identification of one of the respective distributed ledgers in each write request.

Each respective read component and each respective write component may communicate with a respective official distributed ledger client providing an interface to one of the plurality of distributed ledger transaction processing systems. Each respective read component may be configured to optimize the respective data store for reading. Each respective read component may define the respective data store to further include any transaction data related to any unconfirmed transactions associated with the one of the respective distributed ledgers which the respective data store is synchronized.

The particular client wallet may comprise a different unique cryptographic key pair for each different ones of the plurality of systems with which the particular client wallet conducts respective cryptographic transactions, where each different unique cryptographic key pair comprises a private key and a public key, the private key is usable to sign unsigned cryptographic data to generate signed cryptographic data and the public key is usable to generate a plurality of transaction addresses associated with the particular client wallet for conducting the cryptographic transactions. The public key may define a public parent key from which a plurality of public child keys are generated in accordance with a function, each of the public child keys useable to define transaction addresses associated with the particular client wallet. At least some of the plurality of client wallets comprise hierarchical deterministic (HD) wallets having respective public parent keys comprising extended public keys (xPub) in accordance with a Bitcoin Improvement Proposal 32 (BIP32) protocol definition. The cryptographic transaction processing system may be configured to provide a client wallet registration interface to: receive a registration request from one of the plurality of client wallets where the registration request comprises a public parent key associated with one of the plurality of distributed ledger transaction processing systems; and provide a read registration identifier to the one of the plurality of client wallets thereby to facilitate reading respective distributed ledger data associated with transaction addresses which are generated by an address generating component of the cryptographic transaction processing system using the public parent key. The second client wallet facing component may: receives a read request from the one of the plurality of client wallets, the read request including the read registration identifier; and, provide at least one response to the one of the plurality of client wallets in accordance with results of respective read operations performed using the respective data store and respective transaction addresses generated using the public parent key associated with the read registration identifier. The second client wallet facing component may perform the respective read operations for less than all of the transactions addresses capable of generation from the public parent key to reduce read operations for transaction addresses that are unused. The cryptographic transactions may comprise cryptocurrency transactions and the respective read operations may determine cryptocurrency balance data for respective transaction addresses.

There is provided a computing device comprising at least one processor in communication with at least one memory and at least one communication subsystem, the at least one memory storing instructions, which when executed by the at least one processor, configure the computing device to: provide a cryptographic client wallet to conduct cryptographic transactions with a distributing ledger system managing a distributed ledger, the cryptographic transactions communicated to the a distributing ledger system for the cryptographic client wallet via an intermediate cryptographic transaction processing system in communication with the computing device, the cryptographic client wallet operating to: store a public parent key from which a plurality of public child keys are generated in accordance with a function, each of the public child keys useful to define a transaction address to manage with the cryptographic client wallet; transmit a read request to the intermediate cryptographic transaction processing system, the read request including a read registration identifier associated by the intermediate cryptographic transaction processing system with the public parent key of the cryptographic client wallet; and, receive at least one response in accordance with results of respective read operations performed by the intermediate cryptographic transaction processing system using respective transaction addresses generated using the public parent key stored in association with the read registration identifier, the read operations performed to obtain distributed ledger data associated with the respective transaction addresses.

The intermediate cryptographic transaction processing system may maintain a local data store in synchronization with the distributed ledger and performs the read operations using the local data store.

The cryptographic transactions may relate to cryptocurrency and the read operations determine respective cryptocurrency balance data associated with the respective transactions addresses.

The cryptographic client wallet may operate to: transmit a registration request to the intermediate cryptographic transaction processing system, the registration request comprising a public parent key associated with the distributed ledger; and receive the read registration identifier in reply to the registration request.

The cryptographic client wallet may operate to: conduct cryptographic transactions with a plurality of distributing ledger systems managing respective distribute ledgers; store respective public parent keys for at least some the plurality of distributed ledger systems; and register each of the respective public parent keys with the intermediate cryptographic transaction processing system to facilitate reading operations by the intermediate cryptographic transaction processing system using respective transaction addresses generated by the intermediate cryptographic transaction processing system from each of the respective public parent keys.

The intermediate cryptographic transaction processing system may maintain a plurality of respective local data stores in synchronization with each of the respective distributed ledgers and performs the read operations using the respective local data stores. The cryptographic client wallet may further operates to use a private key to sign transaction data to perform a particular transaction without communicating the private key to the intermediate cryptographic transaction processing system.

### BRIEF DESCRIPTION OF DRAWINGS

FIG. 1 is an illustration of a cryptographic transaction computing system in accordance with an embodiment. The cryptographic transaction computing system comprises a number of components (e.g. computing systems or devices) in communication as further described herein.

FIG. 2 is a block diagram of a client computing device of FIG. 1 in accordance with an embodiment.

FIG. 3 is a block diagram of a transaction signing device of FIG. 1 in accordance with an embodiment.

FIG. 4 is an illustration of a cryptographic transaction computing system in accordance with an embodiment showing further details of an intermediate cryptographic transaction processing system as well as other components. A network component is omitted for clarity.

FIGS. 5-11 are flowcharts showing illustrations of various operations of selected components of the cryptographic transaction computing system of FIGS. 1 and 4.

While references to “an embodiment” or “an example” are used herein, nothing should be implied or understood that features of one embodiment cannot be used or combined with features of another embodiment unless otherwise stated. The various systems, methods and devices shown and described herein may be used together unless otherwise stated.

### DESCRIPTION

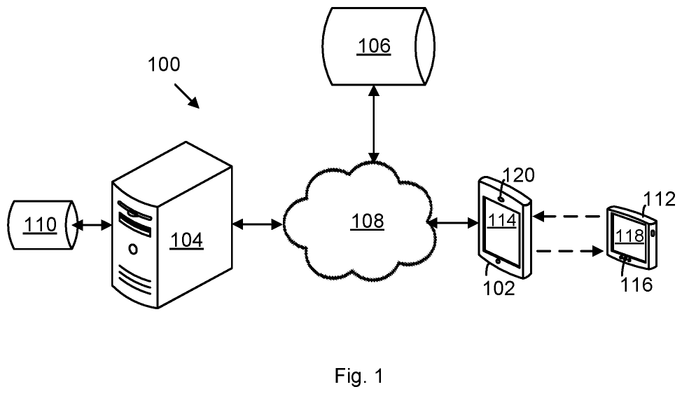

FIG. 1 is an illustration of a cryptographic transaction computing system 100 accordance with an embodiment. The cryptographic transaction computing system comprises a number of components such as computing systems or computing devices in communication as further described herein. Components include a client computing device 102 in communication with an intermediate cryptographic transaction processing system 104 which communicates transactions on behalf of client computing device 102 to a distributed ledger node system 106 managing a distributed ledger 107. Distributed ledger node system 106 and distributed ledger 107 represent a public blockchain which usually comprises a plurality of distributed computing nodes (each node is a computing system) operating together to provide the blockchain (i.e. distributed ledger 107). The blockchain stores distributed ledger data in blocks. Examples of such blockchains include the Bitcoin blockchain and the Ethereum™ blockchain. Respective cryptocurrency coins or tokens exist on top of each blockchain, an example of a coin is a bitcoin which is a unit of transaction within the Bitcoin blockchain. Within the Ethereum blockchain the unit is Ether™ (or ETH) however the Ethereum blockchain also has token which are variables within computer programs running in the Ethereum Virtual Machine. Distributed ledger node system 106 comprises many nodes, each with a copy of the ledger and is shown in a simplified manner in FIG. 1.

The present embodiment shows intermediate cryptographic transaction processing system 104 having a data store 110. Data store 110 stores distributed ledger data from distributed ledger 107 as obtained from one or more nodes of distributed ledger node system 106. Such data preferably includes data from unconfirmed transactions. Data store 110 may be synchronized to ledger 107, comprising an update date in near real time like store of data as stored in the block chain (information quanta or values) but stored in a manner that is optimized for searching/reading, for example, for use to provide balance data in relation to unspent amounts stored at (in association with) an address on the blockchain. Some data from transactions, etc. need not be stored in data store 110 if it is not required to serve a purpose of the data store. It may also store client data related to client computing device 102 as described further. Such data may be stored in separate data store (not shown). Data store 110 or other data stores may be configured as a database such as a relational database.

Intermediate cryptographic transaction processing system 104, as an intermediary component of cryptographic transaction computing system 100, may communicate with fellow components 102 and 106 via a communication network 108, such as a wide area network (WAN), a public network (e.g. the Internet) or via a private network or a combination of same. Communications within intermediate cryptographic transaction processing system 104 may be via a private network and/or public network. Any of the communications between components 102 and 104 and between 106 and 104 may be via wired or wireless means. These devices typically communicate electronically using wire or radio (wireless) components using well known protocols (e.g. Internet Protocols (IP)). Components 102, 104 and 106 are typically dispersed in different physical (geographical) locations and are not local to one another. Components which comprise respective systems 104 and 106 may also be geographically remote from one another. Such components 102, 104 and 106 are often connected to a network or networks for long periods of time and may engage in various communications over the network. Software applications, operating systems and other configurations as well as user behaviour can make these component susceptible to malicious attacks or other malicious activity. It may be desirable to store certain data such as a private key on a computing device for executing cryptographic transactions where the computing device storing such data remains isolated from the communication network 108.

Client computing device 102 is shown in communication with a transaction signing device 112. Transaction signing device 112 comprises a computing device having a special configuration as described further. Broken lines between client computing device 102 and transaction signing device 112 represent an optical over the air (OTA) communication path. Transaction signing device 112 is configured to receive unsigned transaction data optically OTA, sign the data using a private key stored on transaction signing device 112 and transmit signed transaction data optically OTA to client computing device 102. In this way, transaction signing device 112 is isolated from other communication networks, particularly networks such as communication network 108. Transaction signing device 112 is configured without additional communication components for external communications, for example without antenna or external bus connectors, etc. as further described. In one example, the optical OTA communication comprises displaying an image on an optical output device (e.g. a display screen 114) of client computing device 102 and capturing an image using an optical input device (e.g. a camera 116) of transaction signing device 112. Transaction signing device 112 may communicate to client computing device 102 by displaying an image on optical output device (e.g. a display screen 118) for capture by an optical image device (e.g. a camera 120). In another example, the optical input devices and optical output devices may be infrared sensors and transmitters.

Cryptographic transaction computing system 100 shows a single client computing device. However, intermediate cryptographic transaction processing system 104 may be configured to communicate with a plurality of client computing devices, for example, thousands or more. Intermediate cryptographic transaction processing system 104 may be configured to communicate with a plurality of different blockchains provided by different distributed ledger systems (e.g. 106A) and distributed ledgers (e.g. 107A) using respective components of intermediate cryptographic transaction processing system 104 as described further. Each client computing device 102 may be configured to perform transactions via intermediate cryptographic transaction processing system 104 with more than one respective blockchain of the plurality of different blockchains. Client computing device 102 may be (e.g. provide) a multi-coin/multi asset wallet.

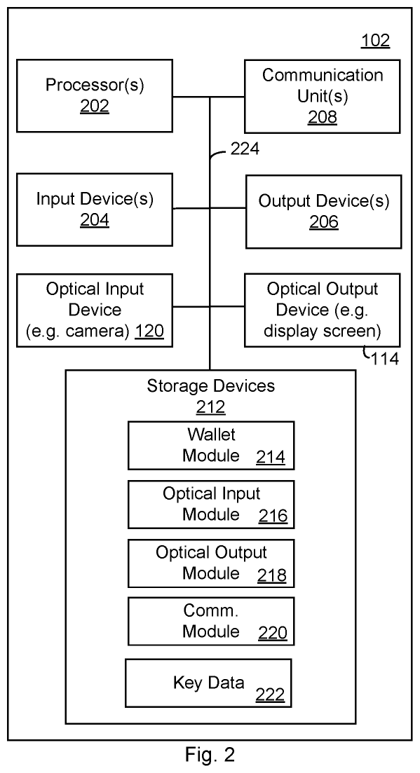

FIG. 2 is a block diagram of client computing device 102 of FIG. 1 in accordance with an embodiment. Client computing device 102 comprises one or more processors 202, one or more input devices 204 as well as an optical input device. Input devices may be a keyboard, key pad, buttons, pointing device, microphone, etc. The optical input device may comprise a camera 120 or an IR sensor (receiver). If the optical input device is an IR sensor, one of the input devices may be a camera. Client computing device 102 may have more than one camera. Client computing device 102 comprises one or more output devices 206 as well as at least one an optical output device. Output devices may include a speaker, light, bell, vibratory device, etc. An optical output device may be display screen 114 or an IR transmitter or a projector. Client computing device 102 may have more than one display screen. It is understood that a display screen used in client computing device 102 may be configured as an input device as well, for example, a gesture based device for receiving touch inputs according to various known technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

Client computing device 102 comprises one or more communication units 208 (e.g. Antenna, induction coil, external buses (e.g. USB, etc.), etc.) for communicating via one or more networks.

Client computing device 102 further comprises one or more storage devices 212. The one or more storage devices 212 may store instructions and/or data for processing during operation of client computing device 102. The one or more storage devices may take different forms and/or configurations, for example, as short-term memory or long-term memory. Storage devices 212 may be configured for short-term storage of information as volatile memory, which does not retain stored contents when power is removed. Volatile memory examples include random access memory (RAM), dynamic random access memory (DRAM), static random access memory (SRAM), etc. Storage devices 212, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Storage devices 212 store instructions and/or data for client computing device 102, which instructions when executed by the one or more processors 202 configure client computing device 102. Instructions may be stored as modules such as a wallet module 214 for performing cryptographic transactions (e.g. transfers of cryptocurrency), optical input module 216, optical output module 218 and communications module 220. Communications module 220 may provide communications capabilities using communication units 208 to communicate with component 104 or other computing devices (not shown). Other modules are not shown such as an operating system, etc. Storage devices 212 store data such as key data 222 as described further.

Communication channels 224 may couple each of the components 114, 120, 202, 204, 206, 208, 212, 214, 216, 218, 220 and 222 for inter-component communications, whether communicatively, physically and/or operatively. In some examples, communication channels 224 may include a system bus, a network connection, an inter-process communication data structure, or any other method for communicating data.

In the examples herein, client computing device 102 is a mobile phone. Other examples of client computing device 102 may be a tablet computer, a personal digital assistant (PDA), a laptop computer, a tabletop computer, a portable gaming device, a portable media player, an e-book reader, a watch, a personal computer or workstation or another type of computing device.

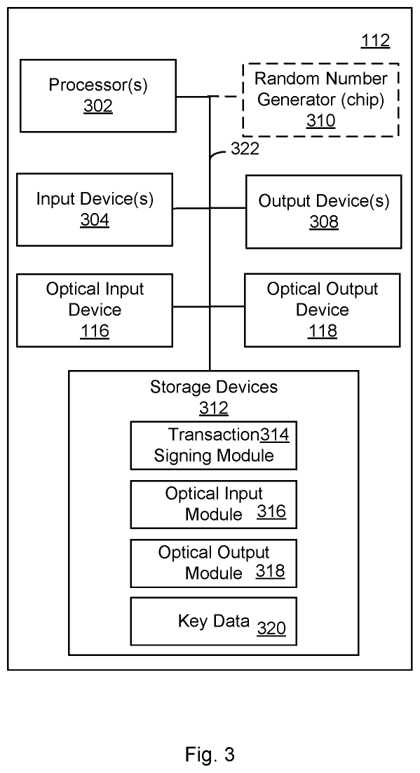

FIG. 3 is a block diagram of a transaction signing device 112 of FIG. 1 in accordance with an embodiment. Transaction signing device 112 is an example of a computing device having limited functionality so as to keep transaction signing device 112 isolated from computer networks and devices thereon, limiting how the transaction signing device 112 may communicatively couple with another computing device, such as client computing device 102.

Transaction signing device 112 comprises one or more processors 302, one or more input devices 304 as well as an optical input device. Input devices may be a keyboard, key pad, buttons, pointing device, microphone, etc. in this small form factor device input devices are typically buttons. The optical input device may comprise a camera or an IR sensor (receiver). If the optical input device is an IR sensor, one of the input devices may be a camera. Transaction signing device 112 may have more than one camera. Transaction signing device 112 may comprise one or more output devices 308 as well as an optical output device. Output devices may include a speaker, light, bell, vibratory device, etc. The optical output device may be a display screen 118 or an IR transmitter or a projector. Transaction signing device 112 may have more than one display screen. It is understood that a display screen used in transaction signing device 112 may be configured as an input device as well, for example, a gesture based device for receiving touch inputs according to various known technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display). Given a preferred small form factor, the number and type of input and output devices may be limited to keep the device to a desired size and cost at the expense of limiting other functionality. Transaction signing device 112 may be limited to receiving unsigned transaction data optically OTA, signing the unsigned transaction data using a private key stored to the transaction signing device 112 and transmitting the signed transaction data optically OTA. In other examples it may provide cold storage features, storing certain cryptographic transaction data offline, which data is received optically OTA or by (manual) input.

Unlike client computing device 102, transaction signing device 112 does not comprise one or more communication units (e.g. Antenna, induction coil, external bus connectors (e.g. USB, etc.), etc.) for communicating with other device such as via one or more networks.

Transaction signing device 112 may comprise a (rechargeable) battery (not shown) which may be removed for replacement or recharging as the case may be. A rechargeable battery may be charged using conventional charging means that do not provide a communication means to transaction signing device 112 (e.g. using DC charger input rather than USB or similar).

Optionally, designated by the broken lines, transaction signing device 112 may comprise a random number generator 310 such as a chip for generating random numbers with which to define key data for cryptographic transactions.

Transaction signing device 112 further comprises one or more storage devices 312. The one or more storage devices 312 may store instructions and/or data for processing during operation of transaction signing device 112. The one or more storage devices may take different forms and/or configurations, for example, as short-term memory or long-term memory. Storage devices 312 may be configured for short-term storage of information as volatile memory, which does not retain stored contents when power is removed. Volatile memory examples include random access memory (RAM), dynamic random access memory (DRAM), static random access memory (SRAM), etc. Storage devices 212, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Storage devices 312 store instructions and/or data for transaction signing device 112, which instructions when executed by the one or more processors 302 configure the transaction signing device 112. Instructions may be stored as modules such as a transaction signing module 314 for performing signing data for cryptographic transactions (e.g. transfers of cryptocurrency), optical input module 316 and optical output module 318. Also stored in storage devices 312 is key data 320 such as a private key to sign data. Other modules are not shown such as an operating system, etc. The functionality of the OS and modules may be limited to suit the limited functionality of transaction signing device 112, a special purpose device.

Though not shown, the components of transaction signing device 112 are housed in a ruggedized manner so as to be protected against solid objects (e.g. penetration), protected against liquids (e.g. water resistant), protected against mechanical impacts (e.g. drops), and protected against temperature (e.g. low temp and/or high temp resistant). Devices may be configured and/or tested in accordance with one or more standards such as “MIL-STD-810, Environmental Engineering Considerations and Laboratory Tests” and/or NEMA (National Electrical Manufacturers Association) IEC (International Electrotechnical Commission) 60529 Degrees of Protection Provided by Enclosures—IP (Ingress Protection) Code. The device may have an alloy backbone and may employ silicone or other gaskets and selected display glass types and plastics such as nylon, polyether ether ketone (PEEK) and reinforced polycarbonate to provide the desired characteristics.

In the examples herein, transaction signing device 112 is a special purpose device having a small form factor. In an embodiment where the optical output device is a display screen, transaction signing device 112 is sufficiently large and any display screen of sufficient resolution to display an image encoding signed transaction data (e.g. a 2D barcode) for communicating optically OTA to a camera of a client computing device 102.

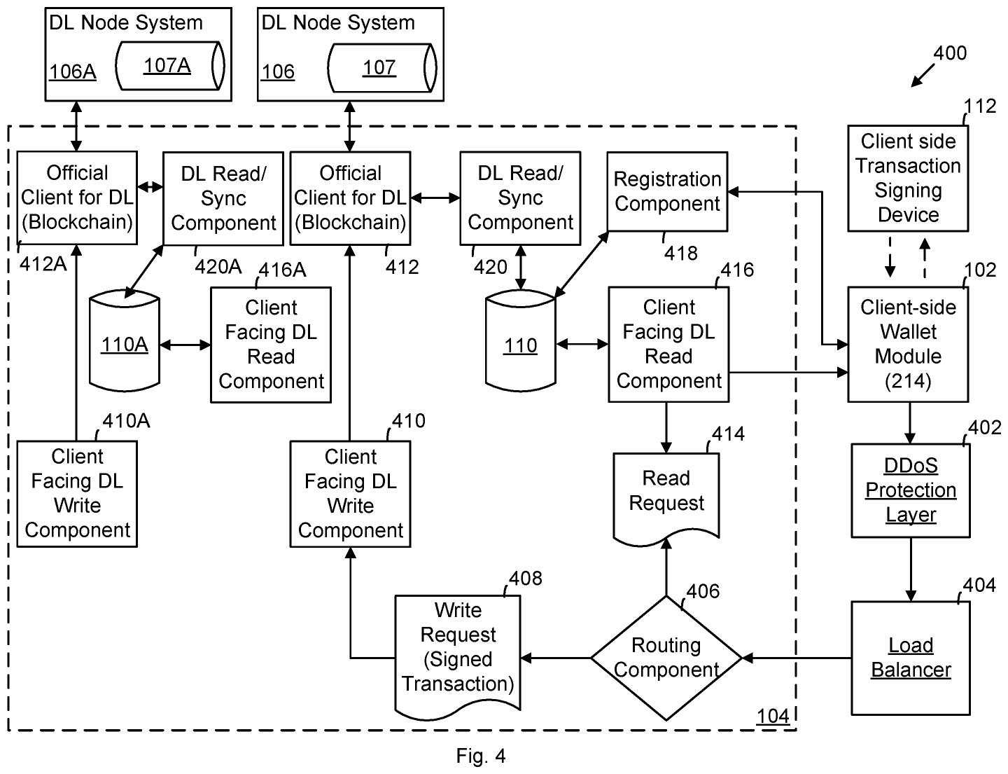

FIG. 4 is an illustration of a cryptographic transaction computing system 400 similar to cryptographic transaction computing system 100 in accordance with an embodiment. FIG. 4 shows further details of intermediate cryptographic transaction processing system 104 as well as other components (e.g. 402 and 404). Network components (e.g. communication network 108) are omitted for clarity. Various components in FIG. 4, such as intermediate cryptographic transaction processing system 104, may be implemented using servers or other computing devices having one or more processors configured via software (e.g. instructions for execution stored in storage devices such as memory etc. as described herein. Such systems may have communication units for communicating internally or externally. Any computing system herein may be a collection of servers, etc.

There is shown client computing device 102 comprising a (client-side) wallet module 214 which may be configured as a client application in software. Client computing device 102 communicates for cryptographic transactions using intermediate cryptographic transaction processing system 104 as an intermediary to distributed ledger node system 106 and distributed ledger 107. Two types of requests for such services may be communicated by client computing device 102. Read requests ask intermediate cryptographic transaction processing system 104 to provide distributed ledger data from distributed ledger 107. Write requests ask intermediate cryptographic transaction processing system 104 to broadcast (communicate) transactions for processing by distributed ledger node system 106. As noted, distributed ledger node system 106 and distributed ledger 107 are typically implemented by a peer-to-peer (P2P) network of nodes and client computing devices such as 102 are assisted by intermediate cryptographic transaction processing system 104 to communicate with such a network of nodes. Respective read and write requests relate to one or more addresses (transaction addresses) managed by wallet module 214. Wallet module 214 may store key data for generating such addresses. Read requests usually seek cryptocurrency balance information (e.g. unspent amounts) for coins/tokens (cryptocurrency) associated with a respective address managed by the transaction device. Write requests perform a transaction such as a payment or other transfer to a recipient (and possibly an associated change output for any remaining balance of the paying party). Write requests require signing using a private key. Signing may be performed using transaction signing device 112 which stores the private key. In some examples, transaction signing device 112 is not present and client computing device 102 stores the private key to sign the transaction data.

Some distributed ledger systems, including Bitcoin, follow a model known as UTXO or “unspent transaction outputs” to store data about transactions and user balances. Each UXTO is associated with an address in the ledger (i.e. on the blockchain). A list of unspent amounts that have been sent to a user in a particular ledger is useful to determine that user's balance (provided they have not been transferred from the user). A function of a wallet is to identify the addresses to which a user has keys and thus owns the addresses. A coin is trackable because its transfer is signed (transferred using a key signing step) to another person (i.e. to the other person's address over which the other person has control). A particular transaction is valid in the ledger if ownership over the coin can be proved by the person sending the coin to the other person and there is a sufficient amount of coin. More than one address (unspent amount) may be an input to support payment in a single transaction. The transaction may have multiple inputs (unspent amounts which together support the transaction). Note that alone or when together the input addresses may store an amount of coin that is greater than an amount to be transferred. The transaction then will have a change output reflecting a remaining amount of the UXTO, which is assigned to another address of the person initiating the transfer.

Hence, in the Bitcoin ledger, a UTXO is the amount that is transferred to a Bitcoin address (along with information required to unlock the output amount using a person's key) during a transaction. Received amounts (i.e. existing UTXOs) are used (consumed) individually during a transaction and new outputs (UTXOs) are created—one for the receiver and, if applicable, one for the amount that is left over (change output). Thus, care must be taken when considering an address associated with a UTXO to be spent in a transaction as “from” address.

The amount sent to the recipient becomes a new UTXO in the recipient's address while the change output becomes a new UTXO in the sender's address that may be used in a future transaction. In the Bitcoin model, many addresses are utilized by a single user (e.g. the user's wallet) when receiving many transfers. Addresses are typically not reused and are changed with each transaction, primarily with a view to maintaining privacy and security. The UTXO at a respective address is publicly available data in the ledger. The owner of the UTXO/address is not public in the ledger however. If an address was reused, one may maintain a history of transactions associated with an address to determine patterns and habits and use other information (e.g. from outside the ledger) to determine identity, etc. Determining a user's balance on a ledger requires evaluating each UTXO (i.e. the address associated therewith) in the ledger.

Some ledgers work differently from this UTXO model, such as Ethereum. The account model does not follow the UXTO model. The account model is more similar to a typical bank model where a user sends ETH tokens to and from their own accounts. Tracking individual tokens is more difficult. They are added to and subtracted from a user balance stored relative to an account. Transactions are valid through proof of ownership of the account and the account has sufficient tokens to support the transaction.

Wallet module 214 may implement a deterministic wallet and preferably a hierarchical deterministic (HD) wallet. Wallet module 214 may provide an implementation compliant with various Bitcoin Improvement Proposals (BIPs) such as BIP 32—Hierarchical Deterministic Wallets published at https://github.com/bitcoin/bips/blob/master/bip-0032.mediawiki; and BIP 39—Mnemonic code for generating deterministic keys published at https://github.com/bitcoin/bips/blob/master/bip-0032.mediawiki; each of which is incorporated herein by reference.

In some examples, wallet module 214 generates the key data 222. The private key data of key data 222 generated may be input into transaction signing device 112 for storing as key data 320. It may be deleted from client computing device 102. It may be communicated optically OTA from client computing device 102 to transaction signing device 112 such as by encoding the key data in an encoded image, displaying the image via the optical output device (e.g. on display screen 114) and receiving the encoded image at transaction signing device 112 via the optical input device (e.g. camera 116). In other examples it may be transmitted using IR signals between the devices. Key data may include seed data for generating specific keys. Seed data may be represented as mnemonics and displayed via the optical output device. This seed data may be optically communicated OTA to transaction signing device 112 for reading by a camera. OCR techniques may be used to determine the characters. In other examples, the mnemonics may be input such as by typing or by voice input. The mnemonics may be used to lookup generate binary key seed data to generate keys for deterministic wallets.

In some examples, transaction signing device 112 may generate the key data 320 for a wallet (e.g. key seed and one or more pairs of public and private keys) and may use a random number generator 310 for example. Key generation for deterministic wallets is known to those of skill in the art and the function(s) therefor is(are) described in BIP 32. The representation of cryptographic key seed data as mnemonics is well known and described in BIP 39. Transaction signing device 112 may implement all or a portion of such BIPs for key generation. In accordance with the key derivation specification, deterministic wallets comprise one or more chains of keypairs of public and private keys. A single chain may comprise a practically infinite number (billions) of keypairs with which transactions may be conducted. The BIP 32 specification provides operations to generate a number of child keys from a parent key. The parent key is extended (with bits of entropy) and functions applied to define a chain of keypairs, both private and public. Importantly, given a parent extended key and an index i, it is possible to compute the corresponding child extended key, where i is the index in the chain of keypairs. Thus a parent extended public key (referenced as an xPub) may be shared with another device so that the xPub may be used to generate child extended public keys. These child extended public keys are useful as transaction addresses for cryptographic transactions. For security purposes, sharing a private key is not suggested as it gives a receiving device the ability to conduct a transaction (e.g. sign unsigned transaction data). Thus sharing a private key with another device is suggested to be restricted to sharing with devices that are under a same user control or other trusted control. However, BIP32 does provide a specification which permits a full wallet sharing among devices, for example, where both wallets wish to be able to perform spending through sharing a xPriv, the parent extended private key.

Thus in accordance with an embodiment of the teachings herein where transaction signing device 112 generates the key data, the xPriv and xPub keys may be generated by transaction signing device 112 and the xPub key shared with client computing device 102. In another embodiment where client computing device 102 or another device generates the key data, xPriv is generated elsewhere (e.g. client computing device 102 or another wallet device) and shared with transaction signing device 112. The corresponding xPub may also be shared, for example, for storage. Similarly a key seed such as a mnemonic may be generated by transaction signing device 112 or shared with it and stored thereon for later regenerating keys, as may be applicable.

In one embodiment, client computing device 102 may communicate a read request for each transaction address managed by client computing device 102. Over time as more transactions are conducted and as transaction addresses for receiving payments are often used only once, client computing device 102 will have more and more used transaction addresses. A wallet application (e.g. wallet module 214) is usually configured to periodically check cryptocurrency balance information for the transaction addresses managed by the wallet. These operations may generate and communicate thousands of read requests each day if a single request is sent for each address in each instance of a period. This state of affairs is compounded when a wallet module manages transaction addresses for a plurality of different cryptocurrencies, (e.g. a multi coin/multi asset wallet) storing respective key data for each respective distributed ledger system and distributed ledger with which it conducts the transactions. As discussed further and in accordance with the teaching herein, a wallet module may register its xPubs for respective distributed ledger systems and distributed ledgers to receive a read registration identifier from intermediate cryptographic transaction processing system 104. Then, rather than send individual read request per transaction address, a read request comprising the read registration identifier may be communicated to perform a “bulk read” where intermediate cryptographic transaction processing system 104 uses the xPub to determine the addresses to read. Private keys are not shared with intermediate cryptographic transaction processing system 104.

In one manner, one registration identifier is associated with multiple xPubs. The registration identifier is itself derived from the same source as the xPubs. Each distributed ledger (e.g. blockchain) has its own xPub (at least 1, if not 2 or more). Which xPub to use with which distributed ledger may be determined by using a distributed ledger identifier stored with the xPub. For example, the system may store “BTC=xPub34903, ETH=xPub34231, etc.”

Client computing device 102 communicates requests to intermediate cryptographic transaction processing system 104. Such requests may be first directed through a Distributed Denial of Service (DDos) protection layer component 402 (e.g. one or more servers hosting applicable software) or other security layers (not shown) as is known to those of skill in the art. Vetted requests are passed to an optional load balancer component 404 (e.g. one or more servers hosting applicable software) for distributing to one or more routing components 406. It will be appreciated that components 402 and 404 may be separate components from intermediate cryptographic transaction processing system 104, per se, provided by a third party service provider. In some embodiments, load balancer component 404 or DDoS Protection Layer component 402 or both may be components of intermediate cryptographic transaction processing system 104.

Routing component 406 routes write requests (e.g. 408) and read requests (e.g. 414) to different components of intermediate cryptographic transaction processing system 104. A write request is the only type of request that is signed by a client's private key, for example using transaction signing device 112. A write request is an instance of a transaction with the distributed ledger 107. For example, in a Bitcoin blockchain transaction, the write request is a transfer of an unspent amount to another user's address, which may result in a change output relative to the sending party.

A write request 408 is routed to a client facing distributed ledger write component 410. Client facing distributed ledger write component 410 may be configured as an API (Application Programming Interface). Client facing distributed ledger write component 410 is configured to submit broadcast requests to the distributed ledger 107 (e.g. blockchain). Client facing distributed ledger write component 410 is configured to use an official client for the distributed ledger 412. The term “broadcast” is used here as the distributed ledger system 106 is (often at least) a peer-to-peer network.

Write requests do return a success or failure confirmation or feedback, per se. The true measure of success is whether the write request makes it into a block (i.e. “confirmation” by the distributed ledger). The client facing distributed ledger write component 410 may receive a confirmation from an official client (daemon) for the distributed ledger 412 that the write request was received properly by the daemon, but that doesn't mean that the transaction will be included in a block. Such a confirmation requires a later read request to see whether the transaction was incorporated into a block.

A read request 414 is routed to client facing distributed ledger read component 416. The read request may include a transaction address where the read request requests distributed ledger data associated with the transaction address. Or read request 414 may include a read registration identifier (not shown) for an associated xPub that was registered to intermediate cryptographic transaction processing system 104. For example, client computing device 102 may communicate a registration request to registration component 418, providing an xPub for the associated distributed ledger and receive a read registration identifier. Registration component 418 may register the xPub (i.e. store it) in data store 110 or another data store (not shown). Client facing distributed ledger read component 416 then uses the transaction address from the request or one or more transaction addresses generated using the xPub associated with the read registration identifier from the request to obtain distributed ledger data associated with the address or addresses as the case may be for communicating to client computing device 102. The read registration identifier may identify more than one xPub for use to generate the public keys that are then hashed accordingly (e.g. double hashed) to generate the addresses for reading to determine balances and transactions.

In one embodiment as shown, client facing distributed ledger read component 416 reads such distributed ledge data from data store 110 which stores a synchronized ledger as maintained by a distributed ledger read and synchronize component 420. Distributed ledger read and synchronize component 420 interfaces with ledger 107 via official client for the distributed ledger 412. Distributed ledger read and synchronize component 420 optimizes data store 110 for reading distributed ledger data. Such data includes (confirmed) data stored to the ledger 107 as well as data from unconfirmed transactions. Such types of data are typically stored in different parts of a distributed ledger 107. In a blockchain data for unconfirmed transactions is retrieved from a memory pool (“mempool”) which is in sync with all the nodes in distributed ledger node system 106. Distributed ledger read and synchronize component 420 frequently interfaces with distributed ledger 107 to refreshes frequently with mempool transactions.

Distributed ledger read and synchronize component 420 comprises small, efficient programs running constantly that synchronize at least one local data store 110 (e.g. at least one database) to its ledger 107. The data is read through JSON-RPC calls or REST calls. These are APIs exposed by the blockchain “daemon” or “official client”. The blockchain data received is transformed into a format that can be more easily and quickly read by the database program, which is in a different format than the underlying blockchain data.

In general, there are two main types of blockchain implementations in practice: account-based and UTXO-based blockchains. Bitcoin and its derivatives are UTXO-based, which means that there are inputs and outputs to each transaction—transactions are composed of one or more inputs and one or more outputs. Account-based systems, like Ethereum, operate using accounts and balances in a manner called “state transitions”. Transactions send from one or more accounts to one account. In both types, the respective local data store 110 is synchronized to the remote ledger 107. The remote ledger 107 is a database used by the blockchain's official client daemon. This is typically a LevelDB database. LevelDB is a fast key-value storage library written at Google® that provides an ordered mapping from string keys to string values. LevelDBs are not Structured Query Language (“SQL”) databases. LevelDBs do not have a relational data model, do not support SQL queries and do not have support for indexes. For efficient reading, the local data store 110 may configured to provide several database tables that contain different kinds of information, indexed according to the type of information that a wallet would need to know. Thus the data store 110 and/or distributed ledger read and synchronize component 420 is configured to index blockchain ledger data by address or transaction ID, in different tables for optimization.

In another embodiment (not shown) intermediate cryptographic transaction processing system 104 may read data from distributed ledger 107 via the official client for the distributed ledger 412 rather than from a local data store (e.g. 110). Such reading is problematic for the peer-to-peer network, where each read establishes a ledger call/inquiry. Only a limited number of connections per each node may be maintained. The structure may be overwhelmed with too many requests.

When intermediate cryptographic transaction processing system 104 is configured to interface with a plurality of different distributed ledger systems such as 106A having respective ledgers such as 107A, intermediate cryptographic transaction processing system 104 may have respective dedicated components to perform the various functions related to a particular ledger system and ledger. For example, intermediate cryptographic transaction processing system 104 may have a respective client facing DL write component (e.g. 410A) and respective client facing DL read component 416A to receive write and read requests (not shown) from client devices (e.g. 102); a respective DL read/sync component 420A and a respective data store 110A. Routing component 406 may receive all requests from all devices and route accordingly (not shown). Registration component 418 may receive xPub registrations for all types of distributed ledgers and store xPubs to a respective local data store (e.g. 110A, etc.). A separate registration component for each ledger type may be provided (not shown). All xPub registrations may be stored to a single common registration data store (not shown).

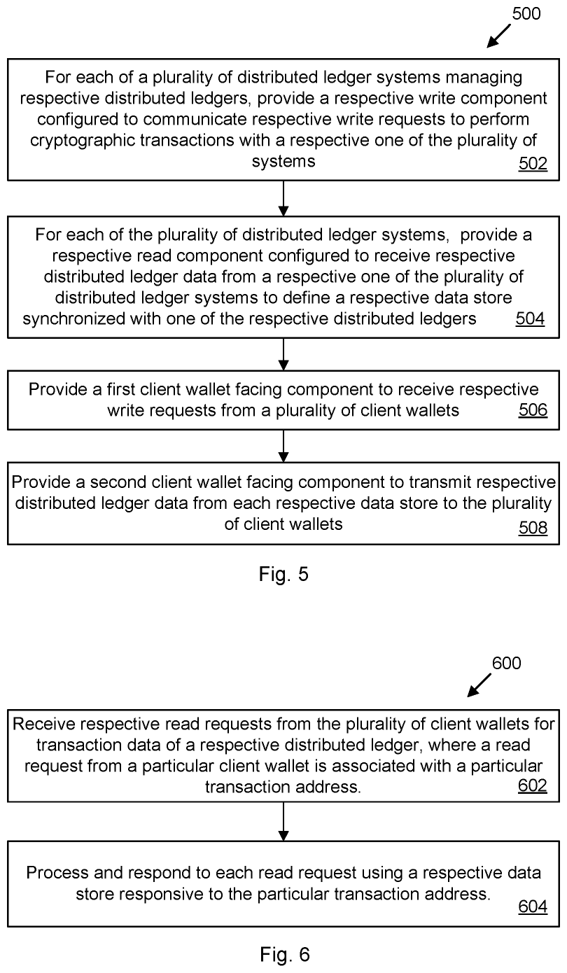

FIGS. 5-11 are flowcharts showing illustrations of various operations of selected components of the cryptographic transaction computing system of FIGS. 1 and 4.

FIG. 5 shows a flowchart of operations 500 of a cryptographic transaction processing system, such as intermediate cryptographic transaction processing system 104, comprising at least one processor in communication with at least one memory and at least one communication subsystem. The at least one memory stores instructions, which when executed by the at least one processor, configure the cryptographic transaction processing system to perform operations, including operations 500. At 502, for each of a plurality of distributed ledger systems managing respective distributed ledgers, the cryptographic transaction processing system provides a respective write component configured to communicate respective write requests to perform cryptographic transactions with a respective one of the plurality of systems; and at 504 it provides a respective read component configured to receive respective distributed ledger data from a respective one of the plurality of distributed ledger systems to define a respective data store synchronized with one of the respective distributed ledgers.

The system provides interfaces for client devices as well. At 506 it provides a first client wallet facing component to receive respective write requests from a plurality of client wallets; and at 508 it provides a second client wallet facing component to transmit respective distributed ledger data from each respective data store to the plurality of client wallets.

In accordance with an example, a particular write request comprises signed cryptographic data having a transaction address associated with a particular client wallet initiating the particular write request for a particular cryptographic transaction. The respective distributed ledgers store ledger data in association with transaction address such that the respective distributed ledger data is associated with respective transaction addresses respectively managed by the plurality of client wallets. Further the second client wallet facing component uses the respective transaction addresses to determine which client wallet is to receive the respective distributed ledger data.

The distributed ledgers may use various models. At least some of the distributed ledgers are configured according to an unspent transaction output (“UTXO”) model and the transaction addresses for the at least some of the distributed ledgers are addresses to store unspent transaction outputs in respective ones of the at least some of the distributed ledgers.

FIG. 6 is a flowchart of operations 600 of the system. At 602, the second client wallet facing component receives respective read requests from the plurality of client wallets for transaction data of a respective distributed ledger, where a read request from a particular client wallet is associated with a particular transaction address. At 604 the second client wallet facing component processes and responds to each read request using a respective data store responsive to the particular transaction address. In accordance with an example, each of the respective read requests includes data identifying a respective one of the plurality of distributed ledgers for use to determine the respective data store to be used. The cryptographic transaction processing system may comprise a routing component and be configured to operate to route each of the read requests and write requests to particular ones of the respective read components and respective write components in accordance with a read or write type of and an identification of the respective distribute ledger in a particular request.

The cryptographic transaction processing system may be configured to operate such that each respective read component and each respective write component communicates with a respective official distributed ledger client providing an interface to one of the plurality of distributed ledger transaction processing systems.

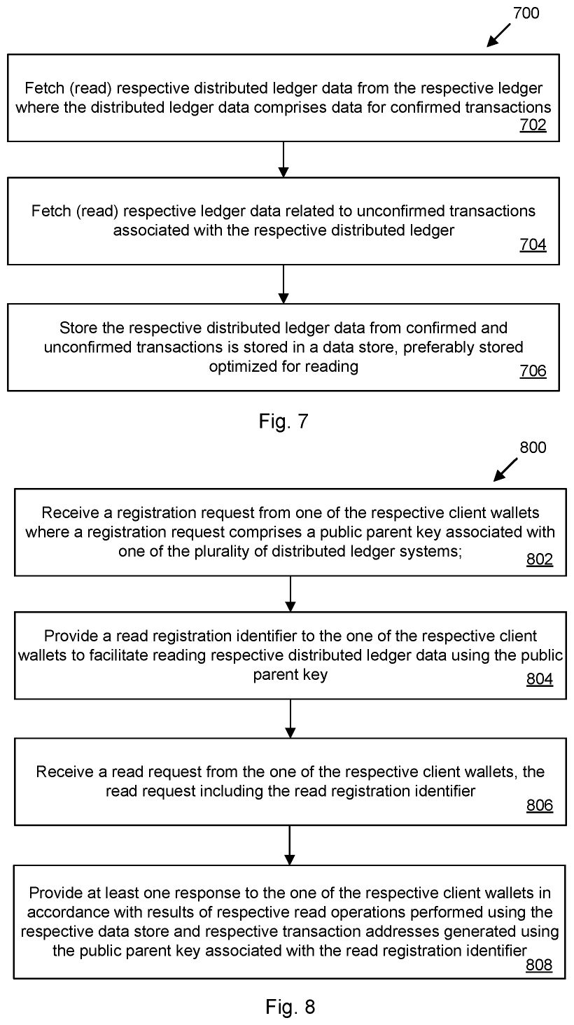

FIG. 7 is a flowchart of operations 700 of the cryptographic transaction processing system, showing operations of an example read component configured in more detail as it receive respective distributed ledger data from a respective one of the plurality of distributed ledger systems to define a respective data store synchronized with one of the respective distributed ledgers.

At 702, the read component fetches (reads) respective distributed ledger data from the respective ledger where the distributed ledger data comprises data for confirmed transactions. In one example, this data is stored in a block of a blockchain once the transactions are confirmed by nodes of the distributed ledger system. Preferably, at 704 the read component further fetches respective ledger data related to unconfirmed transactions associated with the respective distributed ledger. In one example this data is stored in memory pools (mempools) as it awaits processing/confirmation. At 706, the respective distributed ledger data from confirmed and preferably unconfirmed transactions is stored in a data store. It will be understood that these storing operations may be performed separately. The respective ledger data may be optimized for reading. For example, data may not be stored in a block as stored in the blockchain but in records stored for easier reading. As such the read component and/or data store may be configured to optimize the respective data for reading.

The cryptographic transaction processing system may communicate with respective client wallets and a respective wallet may comprise a different unique cryptographic key pair for each different ones of the plurality of distributed ledger systems with which the respective client wallet conducts respective cryptographic transactions. Each different unique cryptographic key pair comprises a private key and a public key. The private key is usable to sign unsigned cryptographic data to generate signed cryptographic data. The public key is usable to generate a plurality of transactions addresses associated with the particular client wallet for conducting the cryptographic transactions. Various functions to generate keys and addresses may be employed according to definitions and/or models implemented by the respective distributed ledger systems and wallets compliant with such systems.

In one example, the public key may define a public parent key from which a plurality of public child keys are generated in accordance with a function where each of the public child keys is useful to define a transaction address associated with the particular wallet. The cryptographic transaction processing system of claim 10 wherein at least some of the respective client wallets comprise hierarchical deterministic (HD) wallets having respective public parent keys comprising extended public keys (xPub) in accordance with the Bitcoin Improvement Proposal 32 (BIP32) protocol definition.

FIG. 8 is a flowchart of operations 800 of the cryptographic transaction processing system. The client wallet registration interface may operate to: at 802, receive a registration request from one of the respective client wallets where a registration request comprises a public parent key associated with one of the plurality of distributed ledger systems; and at 804, provide a read registration identifier to the one of the respective client wallets thereby to facilitate reading respective distributed ledger data associated with transactions addresses which are generated by an address generating component of the cryptographic transaction processing system using the public parent key. Operations 802 and 804 may be provided by a client wallet registration interface provided by the cryptographic transaction processing system.

At 806 operations of the cryptographic transaction processing system (e.g. by the second client wallet facing component) receive a read request from the one of the respective client wallets, the read request including the read registration identifier; and, at 808 provide at least one response to the one of the respective client wallets in accordance with results of respective read operations performed using the respective data store and respective transaction addresses generated using the public parent key associated with the read registration identifier.

It is understood that a client wallet may manage many addresses and potentially many millions of addresses, generatable from a parent public key and that only a small subset of the generatable addresses may be used by the wallet. Thus, the cryptographic transaction processing system (e.g. the read component) may be configured to perform read operations for less than all of the transaction address generatable from the public parent key to reduce read operations for transaction addresses that are unused. Addresses generateable from the public parent key are usually generated in a chain having a respective index and are used in order (e.g. from 0 up the index, etc.) Reads for addresses at respective indexes may return no data from the data store and if a sufficient number are not located then reading from the chain may cease.

For any of the operations of the cryptographic transaction processing system the cryptographic transactions may comprise cryptocurrency transactions. The read operations may determine cryptocurrency balance data for respective transaction addresses.

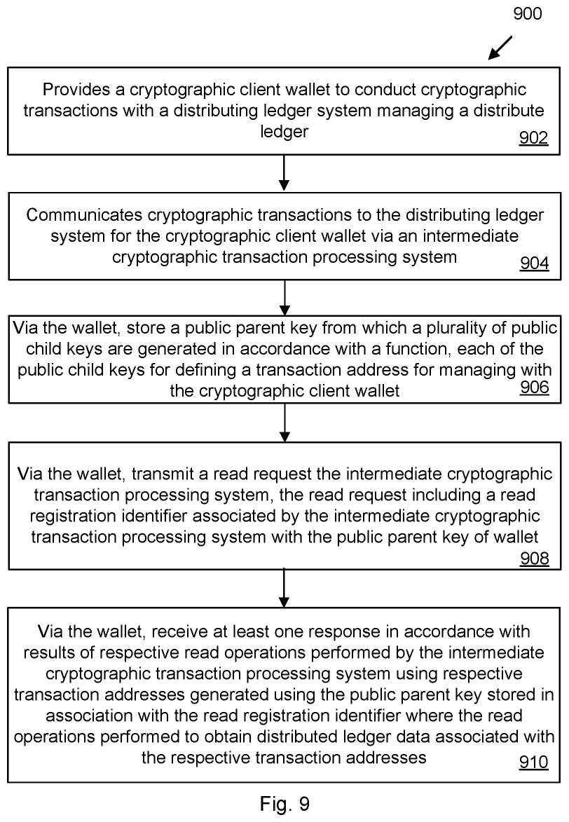

FIG. 9 shows operations 900 of a computing device. The computing device may be a client computing device such as client computing device 102. The computing device comprises at least one processor in communication with at least one memory and at least one communication subsystem. The at least one memory stores instructions, which when executed by the at least one processor, configure the computing device to perform operations such as operations 900.

At 902 the computing device provides a cryptographic client wallet to conduct cryptographic transactions with a distributing ledger system managing a distribute ledger. At 904 via the wallet, the computing device communicates cryptographic transactions to the distributing ledger system for the client wallet via an intermediate cryptographic transaction processing system in communication with the computing device. At 906 the computing device, via the wallet, stores a public parent key from which a plurality of public child keys are generated in accordance with a function, each of the public child keys for defining a transaction address for managing with the cryptographic client wallet. At 908, via the wallet, a read request is transmitted to the intermediate cryptographic transaction processing system. The read request includes a read registration identifier associated by the intermediate cryptographic transaction processing system with the public parent key of wallet.

At 910, at the wallet, at least one response is received in accordance with results of respective read operations performed by the intermediate cryptographic transaction processing system using respective transaction addresses generated using the public parent key stored in association with the read registration identifier where the read operations performed to obtain distributed ledger data associated with the respective transaction addresses.

The intermediate cryptographic transaction processing system may maintain a local data store in synchronization with the distributed ledger and performs the read operations using the local data store.

The transactions may relate to cryptocurrency and the read operations determine respective cryptocurrency balance data associated with the respective transactions addresses.

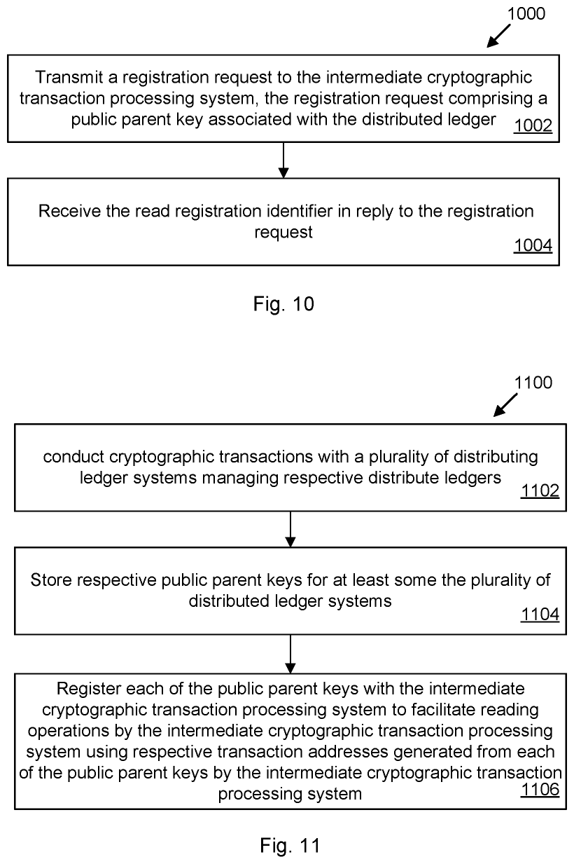

FIG. 10 shows operations 1000 of the computing device. At 1002 client wallet transmits a registration request to the intermediate cryptographic transaction processing system, the registration request comprising a public parent key associated with the distributed ledger. At 1004 the client wallet receives the read registration identifier in reply to the registration request. The read registration identifier may be stored for providing with a read request.

FIG. 11 shows operations 1100 of the computing device. The computing device (e.g. client wallet) may operate to: at 1102, conduct cryptographic transactions with a plurality of distributing ledger systems managing respective distribute ledgers; at 1104, store respective public parent keys for at least some the plurality of distributed ledger systems; and at 1106, register each of the public parent keys with the intermediate cryptographic transaction processing system to facilitate reading operations by the intermediate cryptographic transaction processing system using respective transaction addresses generated from each of the public parent keys by the intermediate cryptographic transaction processing system. The cryptographic transaction processing system may be configured to maintain a respective local data store in synchronization with each of the respective distributed ledgers and perform the read operations using the respective local data stores.

The client wallet may be further configured to use a private key for signing transaction data to perform a particular transaction without communicating the private key to the intermediate cryptographic transaction processing system.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A cryptographic transaction processing system comprising at least one processor in communication with at least one memory and at least one communication subsystem, the at least one memory storing instructions, which when executed by the at least one processor, configure the cryptographic transaction processing system to:
for each of a plurality of distributed ledger transaction processing systems managing respective distributed ledgers:
provide a respective write component to communicate respective write requests to perform cryptographic transactions with a respective one of the plurality of distributed ledger transaction processing systems; and
provide a respective read component to receive respective distributed ledger data from a respective one of the plurality of systems to define a respective data store synchronized with one of the respective distributed ledgers;
provide a first client wallet facing component to receive respective write requests from a plurality of client wallets; and
provide a second client wallet facing component to transmit respective distributed ledger data from each respective data store to the plurality of client wallets; and
wherein a particular write request comprises signed cryptographic data having a transaction address associated with a particular client wallet initiating the particular write request for a particular cryptographic transaction; and
wherein the respective distributed ledger data is associated with respective transaction addresses respectively managed by the plurality of client wallets and the second client wallet facing component uses the respective transaction addresses to determine which client wallet of the plurality of cryptographic client wallets is to receive the respective distributed ledger data.

2. The cryptographic transaction processing system of claim 1 wherein at least some of the respective distributed ledgers are configured according to an unspent transaction output (“UTXO”) model and the transaction addresses for the at least some of the respective distributed ledgers are addresses to store unspent transaction outputs in respective ones of the at least some of the respective distributed ledgers.

3. The cryptographic transaction processing system of claim 1 wherein:
the second client wallet facing component receives respective read requests from the plurality of client wallets for transaction data of the respective distributed ledgers, where a read request is associated with a particular transaction address; and
the second client wallet facing component processes and responds to each read request using the respective data store responsive to the particular transaction address.

4. The cryptographic transaction processing system of claim 3 wherein each of the respective read requests includes data identifying a particular one of the respective distributed ledgers for use to determine the respective data store to be used.

5. The cryptographic transaction processing system of claim 3 comprising a routing component to route each read request to a particular respective read component in accordance with an identification of one of the respective distributed ledgers in each read request, the routing component further routing each write request to a particular respective write component in accordance with an identification of one of the respective distributed ledgers in each write request.

6. The cryptographic transaction processing system of claim 1 wherein each respective read component and each respective write component communicates with a respective official distributed ledger client providing an interface to one of the plurality of distributed ledger transaction processing systems.

7. The cryptographic transaction processing system of claim 1 wherein each respective read component is configured to optimize the respective data store for reading.

8. The cryptographic transaction processing system of claim 1 wherein each respective read component defines the respective data store to further include any transaction data related to any unconfirmed transactions associated with the one of the respective distributed ledgers which the respective data store is synchronized.

9. The cryptographic transaction processing system of claim 1 wherein the particular client wallet comprises a different unique cryptographic key pair for each different ones of the plurality of distributed ledger transaction processing systems with which the particular client wallet conducts respective cryptographic transactions, where each different unique cryptographic key pair comprises a private key and a public key, the private key is usable to sign unsigned cryptographic data to generate signed cryptographic data and the public key is usable to generate a plurality of transaction addresses associated with the particular client wallet for conducting the cryptographic transactions.

10. The cryptographic transaction processing system of claim 9 wherein the public key defines a public parent key from which a plurality of public child keys are generated in accordance with a function, each of the public child keys useable to define transaction addresses associated with the particular client wallet.

11. The cryptographic transaction processing system of claim 10 wherein at least some of the plurality of client wallets comprise hierarchical deterministic (HD) wallets having respective public parent keys comprising extended public keys (xPub) in accordance with a Bitcoin Improvement Proposal 32 (BIP32) protocol definition.

12. The cryptographic transaction processing system of claim 9 configured to provide a client wallet registration interface to:
receive a registration request from one of the plurality of client wallets where the registration request comprises a public parent key associated with one of the plurality of distributed ledger transaction processing systems; and
provide a read registration identifier to the one of the plurality of client wallets thereby to facilitate reading respective distributed ledger data associated with transaction addresses which are generated by an address generating component of the cryptographic transaction processing system using the public parent key.

13. The cryptographic transaction processing system of claim 12 where the second client wallet facing component:
receives a read request from the one of the plurality of client wallets, the read request including the read registration identifier; and,
provides at least one response to the one of the plurality of client wallets in accordance with results of respective read operations performed using the respective data store and respective transaction addresses generated using the public parent key associated with the read registration identifier.

14. The cryptographic transaction processing system of claim 13 wherein the second client wallet facing component performs the respective read operations for less than all of the transactions addresses capable of generation from the public parent key to reduce read operations for transaction addresses that are unused.

15. The cryptographic transaction processing system of claim 13 wherein the cryptographic transactions comprise cryptocurrency transactions and the respective read operations determine cryptocurrency balance data for respective transaction addresses.

16. A computing device comprising at least one processor in communication with at least one memory and at least one communication subsystem, the at least one memory storing instructions, which when executed by the at least one processor, configure the computing device to:
provide a cryptographic client wallet to conduct cryptographic transactions with a distributed ledger system managing a distribute ledger, the cryptographic transactions communicated to the a distributed ledger system for the cryptographic client wallet via an intermediate cryptographic transaction processing system in communication with the computing device, the cryptographic client wallet operating to:
store a public parent key from which a plurality of public child keys are generated in accordance with a function, each of the public child keys useful to define a transaction address to manage with the cryptographic client wallet;
transmit a read request to the intermediate cryptographic transaction processing system, the read request including a read registration identifier associated by the intermediate cryptographic transaction processing system with the public parent key of the cryptographic client wallet; and,
receive at least one response in accordance with results of respective read operations performed by the intermediate cryptographic transaction processing system using respective transaction addresses generated using the public parent key stored in association with the read registration identifier, the read operations performed to obtain distributed ledger data associated with the respective transaction addresses.

17. The computing device of claim 16 wherein the intermediate cryptographic transaction processing system maintains a local data store in synchronization with the distributed ledger and performs the read operations using the local data store.

18. The computing device of claim 16 wherein the cryptographic transactions relate to cryptocurrency and the read operations determine respective cryptocurrency balance data associated with the respective transactions addresses.

19. The computing device of claim 16 wherein the cryptographic client wallet operates to:
transmit a registration request to the intermediate cryptographic transaction processing system, the registration request comprising a public parent key associated with the distributed ledger; and
receive the read registration identifier in reply to the registration request.

20. The computing device of claim 16 wherein the cryptographic client wallet operates to:
conduct cryptographic transactions with a plurality of distributed ledger systems managing respective distribute ledgers;
store respective public parent keys for at least some the plurality of distributed ledger systems; and
register each of the respective public parent keys with the intermediate cryptographic transaction processing system to facilitate reading operations by the intermediate cryptographic transaction processing system using respective transaction addresses generated by the intermediate cryptographic transaction processing system from each of the respective public parent keys.

21. The computing device of claim 20 wherein the intermediate cryptographic transaction processing system maintains a plurality of respective local data stores in synchronization with each of the respective distributed ledgers and performs the read operations using the respective local data stores.

22. The computing device of claim 16 wherein the cryptographic client wallet further operates to use a private key to sign transaction data to perform a particular transaction without communicating the private key to the intermediate cryptographic transaction processing system.

23. A method to process cryptographic transactions by an intermediate cryptographic transaction processing system in communication with a plurality of computing devices providing respective cryptographic client wallets, the method comprising:
for each of a plurality of distributed ledger transaction processing systems managing respective distributed ledgers:
providing a respective write component to communicate respective write requests to perform cryptographic transactions with a respective one of the plurality of distributed ledger transaction processing systems; and
providing a respective read component to receive respective distributed ledger data from a respective one of the plurality of systems to define a respective data store synchronized with one of the respective distributed ledgers;
providing a first client wallet facing component to receive respective write requests from the cryptographic client wallets; and
providing a second client wallet facing component to transmit respective distributed ledger data from each respective data store to the plurality of cryptographic client wallets; and
wherein a particular write request comprises signed cryptographic data having a transaction address associated with a particular client wallet initiating the particular write request for a particular cryptographic transaction; and
wherein the respective distributed ledger data is associated with respective transaction addresses respectively managed by the plurality of cryptographic client wallets and the second client wallet facing component uses the respective transaction addresses to determine which client wallet of the plurality of cryptographic client wallets is to receive the respective distributed ledger data.

24. The method of claim 23 wherein at least some of the respective distributed ledgers are configured according to an unspent transaction output (“UTXO”) model and the transaction addresses for the at least some of the respective distributed ledgers are addresses to store unspent transaction outputs in respective ones of the at least some of the respective distributed ledgers.

25. The method of claim 23 wherein:
receiving at the second client wallet facing component respective read requests from the plurality of cryptographic client wallets for transaction data of the respective distributed ledgers, where a read request is associated with a particular transaction address; and
processing and responding to each read request, by the second client wallet facing component, using the respective data store responsive to the particular transaction address.

26. The method of claim 25 wherein each of the respective read requests includes data identifying a particular one of the respective distributed ledgers for use to determine the respective data store to be used.

27. The method of claim 25 comprising providing a routing component to route each read request to a particular respective read component in accordance with an identification of one of the respective distributed ledgers in each read request, the routing component further routing each write request to a particular respective write component in accordance with an identification of one of the respective distributed ledgers in each write request.

28. The method of claim 23 wherein each respective read component and each respective write component communicates with a respective official distributed ledger client providing an interface to one of the plurality of distributed ledger transaction processing systems.

29. The method of claim 23 wherein each respective read component is configured to optimize the respective data store for reading.

30. The method of claim 23 wherein each respective read component defines the respective data store to further include any transaction data related to any unconfirmed transactions associated with the one of the respective distributed ledgers which the respective data store is synchronized.

31. The method of claim 23 wherein the particular client wallet comprises a different unique cryptographic key pair for each different ones of the plurality of distributed ledger transaction processing systems with which the particular client wallet conducts respective cryptographic transactions, where each different unique cryptographic key pair comprises a private key and a public key, the private key is usable to sign unsigned cryptographic data to generate signed cryptographic data and the public key is usable to generate a plurality of transaction addresses associated with the particular client wallet for conducting the cryptographic transactions.

32. The method of claim 31 wherein the public key defines a public parent key from which a plurality of public child keys are generated in accordance with a function, each of the public child keys useable to define transaction addresses associated with the particular client wallet.

33. The method of claim 32 wherein at least some of the plurality of client wallets comprise hierarchical deterministic (HD) wallets having respective public parent keys comprising extended public keys (xPub) in accordance with a Bitcoin Improvement Proposal 32 (BIP32) protocol definition.

34. The method of claim 31 comprising providing a client wallet registration interface to:
receive a registration request from one of the plurality of client wallets where the registration request comprises a public parent key associated with one of the plurality of distributed ledger transaction processing systems; and
provide a read registration identifier to the one of the plurality of client wallets thereby to facilitate reading respective distributed ledger data associated with transaction addresses which are generated by an address generating component of the cryptographic transaction processing system using the public parent key.

35. The method of claim 34 comprising, by the second client wallet facing component:
receiving a read request from the one of the plurality of client wallets, the read request including the read registration identifier; and,
providing at least one response to the one of the plurality of client wallets in accordance with results of respective read operations performed using the respective data store and respective transaction addresses generated using the public parent key associated with the read registration identifier.

36. The method of claim 35 wherein the second client wallet facing component performs the respective read operations for less than all of the transactions addresses capable of generation from the public parent key to reduce read operations for transaction addresses that are unused.

37. The method of claim 35 wherein the cryptographic transactions comprise cryptocurrency transactions and the respective read operations determine cryptocurrency balance data for respective transaction addresses.

38. A computer-implemented method:
providing, by a computing device comprising at least one processor in communication with at least one memory and at least one communication subsystem, the at least one memory storing instructions, which when executed by the at least one processor, configure the computing device, a cryptographic client wallet to conduct cryptographic transactions with a distributed ledger system managing a distribute ledger, the cryptographic transactions communicated to the a distributed ledger system for the cryptographic client wallet via an intermediate cryptographic transaction processing system in communication with the computing device, the cryptographic client wallet operating to:
store a public parent key from which a plurality of public child keys are generated in accordance with a function, each of the public child keys useful to define a transaction address to manage with the cryptographic client wallet;
transmit a read request to the intermediate cryptographic transaction processing system, the read request including a read registration identifier associated by the intermediate cryptographic transaction processing system with the public parent key of the cryptographic client wallet; and,
receive at least one response in accordance with results of respective read operations performed by the intermediate cryptographic transaction processing system using respective transaction addresses generated using the public parent key stored in association with the read registration identifier, the read operations performed to obtain distributed ledger data associated with the respective transaction addresses.

39. The method of claim 38 wherein the intermediate cryptographic transaction processing system maintains a local data store in synchronization with the distributed ledger and performs the read operations using the local data store.

40. The method of claim 38 wherein the cryptographic transactions relate to cryptocurrency and the read operations determine respective cryptocurrency balance data associated with the respective transactions addresses.

41. The method of claim 38 wherein the cryptographic client wallet operates to:
transmit a registration request to the intermediate cryptographic transaction processing system, the registration request comprising a public parent key associated with the distributed ledger; and
receive the read registration identifier in reply to the registration request.

42. The method of claim 38 wherein the cryptographic client wallet operates to:
conduct cryptographic transactions with a plurality of distributed ledger systems managing respective distribute ledgers;
store respective public parent keys for at least some the plurality of distributed ledger systems; and
register each of the respective public parent keys with the intermediate cryptographic transaction processing system to facilitate reading operations by the intermediate cryptographic transaction processing system using respective transaction addresses generated by the intermediate cryptographic transaction processing system from each of the respective public parent keys.

43. The method of claim 42 wherein the intermediate cryptographic transaction processing system maintains a plurality of respective local data stores in synchronization with each of the respective distributed ledgers and performs the read operations using the respective local data stores.

44. The method of claim 38 wherein the cryptographic client wallet further operates to use a private key to sign transaction data to perform a particular transaction without communicating the private key to the intermediate cryptographic transaction processing system.
